(19) United States
(12) Patent Application Publication
(10) Pub. No.: US 2011/0071251 A1
(43) Pub. Date: Mar. 24, 2011

(54) SILICONATED POLYESTERS AND POLYACRYLATES HAVING A LOW VOC

(76) Inventors: Bogdan Hariton Dana, Perth (AU); Gang Hu, Winnipeg (CA); Ronghua Zheng, Winnipeg (CA)

(21) Appl. No.: 12/992,259

(22) PCT Filed: May 12, 2009
(86) PCT No.: PCT/CA09/00661

§ 371 Date: Nov. 11, 2010

Related U.S. Application Data
(60) Provisional application No. 61/127,307, filed on May 12, 2008.

(51) Int. Cl. C09D 133/14

(52) U.S. Cl. 524/558

(57) ABSTRACT

High solids coating compositions are disclosed, based on polymeric resins synthesized by polycondensation or by solution Free Radical Polymerization FRP and/or Atom Transfer Radical Polymerization ATRP. Two pack coatings with low volatile organic content (VOC) are provided, by curing the above mentioned hydroxy functional polymers, also containing other chemical functional groups in the backbone or side chains (such as oxirane, amino, allyl, halogen) with polyisocyanates and/or amino resins cross-linkers. The coatings thus formulated contain less than about 50% by weight of an organic solvent when applied.

### FIELD OF THE INVENTION

The invention relates to allyl, acrylic and/or polyester polyol polymers and coating compositions based on them, with high solids content and low VOC. The polymers have a certain level of silicone and other functionality coming from functional (meth)acrylic monomers, from silane acrylic monomer/reactive silicone or from a mercaptosilane chain transfer agent.

### BACKGROUND

Due to current pollutions regulations, research and development effort in the field of paints and coating materials has been put into the development of topcoats having low volatile organic content (VOC) without sacrificing the film aesthetic properties and the actual paint sprayability and ease of application. Two component rapid curing acrylic polyurethane coatings have been actively developed. These coatings offer high solids spraying content and low VOC, but still suffer from poor adhesion to metal or other substrates and other drawbacks.

Proposed legislation in the USA and Europe is aimed at reducing the use of organic solvents in order to cut emissions of organic solvents. Although specific legislation governing emissions has been in force in various countries since the 1990s, laws relating to organic solvent emissions are being tightened further, especially in Europe and North America. There are two basic routes for reducing the emissions of volatile organic compounds from solvent based coatings as it follows:
i. the formulation of solvent born coatings with a high solids content: high solids (VOC=420 g/L) and very high solids (VOC 250 g/L)
ii. the formulation of coatings that contain no organic solvents (solvent free paints) such as water born, powder or UV curing coatings. In this case, total removal of solvents to give a zero VOC paint will lead to highly viscous and possibly enormously shear thinning, which will limit the paints' ability to be mixed and pumped during manufacture, and will also limit the formulators' ability to produce a sprayable coating and limits their ability to produce acceptable surface finishes.

One method of alleviating this problem is to use lower molecular weight, hence lower viscosity polymers. This solution tends to be expensive as the methods employed for the synthesis of polymers are yet to become common practice at industrial level for the current coating resins manufacturers. This approach of making low molar mass polymers having low viscosity must not be taken too far, as the resins will yield a highly mobile film before sufficient curing has taken place to overcome sagging and slumping.

For the purposes of this disclosure, low VOC composition refers to coatings composition having less than about 0.6 kilograms of organic solvent per litre (or 5 pounds per gallon), preferably in the range of less than about 0.3 kg/L (2.5 lb/gallon) and most preferably of less than 0.18 kg/L (1.5 pounds per gallon), according to ASTM D3960.

The polymer architectures will not be highly controlled structures with tightly defined molecular weight distributions, branch lengths or block lengths if conventional free radical polymerization (FRP) is employed and it is likely that there will be a population of structures present which are not targeted. Understanding these architectures in detail and the relationship between basic physical properties and applied properties in comparison to highly controlled structures is of benefit.

Typically, polymers can be subdivided into a number of types, according to their structure and manufacturing process. For example, they may be step growth or chain growth, addition or condensation polymers depending on their mechanism of formation. They may be specified as thermoplastic or thermosetting, as linear or cross-linked depending on their structure. They may be classed as block, graft, regular, random, gradient by their morphology and also as isotactic, syndiotactic or atactic by their structures. Addition (chain growth) polymer processes may be free radical, cationic, anionic, metal complex, metal oxide, or metallocene catalyzed. The procedure or technique by which they are made may be bulk, solution, suspension or emulsion polymerization.

Addition polymers may typically be made by four different experimental techniques as mentioned above: bulk, solution, suspension, and emulsion processes.

In bulk polymerization only the monomers and a small amount of catalyst may be present. No separation processes are necessary and the only impurity in the final product is typically monomer. However, heat transfer is a problem as the polymer becomes viscous.

In solution polymerization the solvent dissipates the heat better, but it must be removed later and care must be used in choosing the proper solvent so it does not act as a chain transfer agent.

In suspension polymerization the monomer and catalyst are suspended as droplets in a continuous phase such as water by continuous agitation.

Emulsion polymerization uses an emulsifying agent such as soap, which forms micelles where the polymerization takes place.

Bulk (Mass) Polymerisation may be described as mixing the monomer and initiator under heating. It does not give a good control over the temperature. The polymers obtained generally have a wide distribution of the molar masses (4<PDI<20 at industrial level).

The polymer obtained is very pure, as the reaction mixture only contains monomer and initiator and it has a relatively high molar mass. Difficulties in removing the heat generated by the reaction are the main drawback of this technique.

Polymerisation in solution (Solution Polymerisation) is accomplished by heating the monomer and initiator with stirring in an appropriate solvent. Monomer and initiator are typically about 40-60% of the solution mass, the rest is solvent. After the conclusion of the reaction, solvent can be removed by distillation or other techniques, although in many cases the polymeric solutions are used as such. The presence of solvent leads to a decrease of monomer-polymer solution viscosity and allows a more uniform stirring.

In general, a free radical solution polymerisation may be controlled by the following factors: reaction temperature, the polymer molar mass decreases with the increase of the reaction temperature.
monomer M concentration—the smaller M is, the lower the molar mass of the polymers obtained.
solvent choice—the molar mass of the final polymer can be altered by some solvents which will also change the viscosity. The initiator reactivity is also influenced by the solvent. The boiling point of the solvent eventually dictates the reaction running temperature of the entire polymerisation process. The popular cheap solvents are the aromatic hydrocarbons, alcohols and ketones. The more expensive ones are esters or glycols. Solvents can also be categorized by the effect they have on polymers. They can be non-solvents, “true” (real solvents) or “latent” (diluents). The “latent solvents” do not dissolve the polymers on their own, but may be used in combination with true solvents.
initiator I concentration—for industrial level polymerisation reactions, concentrations of initiator between 0.2-4% are common, but at laboratory level they can vary between 2-5% molar with respect to the monomer.
chain transfer agent, (CTA)—a CTA agent terminates a growing polymeric chain and generates other radicals. These new radicals can act as “retarders” or “inhibitors”, due to their inability to further react with the monomer (very slow or no reaction at all).
Tromsdorf effect or the so-called “gel” effect is defined as the uncontrolled growth of the polymers' molar masses, together with an overall increase of the solution viscosity.

One current focus is to develop polymerisation reactions that can provide a certain degree of control over the process. Thus leading to polymers with predetermined molar masses and conversions, having a controlled architecture and narrow polydispersity. Some of these techniques are outlined as follows:

Living Polymerisation

A living polymerisation may be described as a reaction where there is no termination and no transfer (kₜ=0, kₜᵣ=0) and the reactive center is not lost from the system, but remains active.

This means that the reaction could be carried out continuously only by feeding the polymer with new monomer intakes. The first living polymerisation achieved was the anionic polymerisation of styrene and 1,3-dienes by Szwarc in mid 1950s.

A plot of the molecular weight against conversion of monomer is linear for a ‘living’ system. This can be compared to the graph one would obtain from a free radical system, where there is an increase of the Mₙ in the initial stage (up to 25-35% monomer conversion) followed by a small drop of the molecular weight. Because the reactive centres do not undergo termination, even if full conversion is reached, if more monomer is added, then further polymerisation will occur. Also the MWD will be narrow and close to 1 (PDI=M_{w}/Mₙ=1.1-1.3).

Until relatively recently, the only systems that exhibited living polymerisation characteristics were ionic, i.e. anionic, cationic, coordinative, but some successful free “living/controlled” radical polymerisation systems are being actively developed.

Living/Controlled Polymerisation

The practical living reactions being developed are often termed ‘living/controlled’ polymerisations and they typically involve a certain degree of termination and transfer, meaning that Rₜ and Rₜᵣ are small, but not equal to zero (kₜ→0, kₜᵣ→0, but kₜ≠0 and kₜᵣ≠0).

A variation for such ‘living/controlled’ polymerization LCP of the acrylic monomer is Atom Transfer Radical Polymerization (ATRP). Other LCP techniques include Nitroxide Mediated Polymerization NMP and Reversible Addition Fragmentation Chain Transfer RAFT.

Atom Transfer Radical Polymerisation, (ATRP)

Atom Transfer Radical Polymerisation (ATRP) is a relatively newly developed technique. It is mediated by a transition metal catalytic complex and it is an effective ‘living/controlled’ polymerisation method not only for acrylates but also for other vinyl monomers.

An ATRP polymerisation system may comprise of monomer, catalytic complex (formed in situ by the combination of a transition metallic salt and a complexing ligand) and an initiator (alkyl halide or sulfonyl halide).

The reaction has a propagation reaction rate constant kₚ and the equilibrium is shifted to the dormant species Pol-X formation:

Pol-X+M″X/L [symbol] Pol^{•}+Mⁿ⁺¹X₂/L

wherein Pol-X is the new end-capped dormant species created through the actual transfer of the halogen radical of the initiator, Pol^{•} is the growing polymer radical, M″X/L and Mⁿ⁺¹X₂/L representing the complex of the transition metal salt and the ligand.

Scheme 1 below presents the composition of an ATRP system, which mainly comprises of monomer, solvent, initiator and catalytic complex:

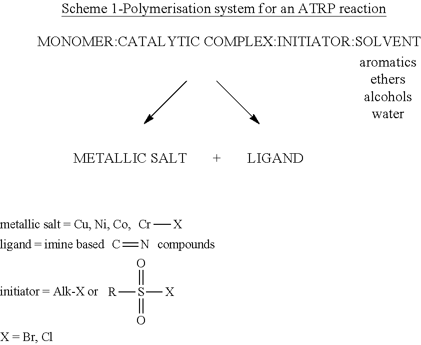

The main advantage induced by ATRP is the synthesis, in mild reaction conditions, of polymers with predetermined architectures and controlled molecular weights, having narrow polydispersities (PDI<1.5). However, it is worth noting the following disadvantages:
the reaction mechanism is not fully understood, even though it is agreed that free radicals are involved or there is another kind of monomer insertion in the C—X bond of the growing species;
there is a certain loss of control at the beginning of the reaction
the final product is contaminated with metal coming from the catalyst, which is not easy to separate from the polymer, although much progress is being made by various methodologies which allow syntheses of pure polymers or easy removal of the catalyst.

Polycondensation or step growth is another method of making industrial copolymers for coating resins. The polymer chains grow slowly through the reaction between two different functional groups, such as hydroxyl and carboxyl, in the case of polyester. In contrast to addition polymerization, a small molecule, such as water, is continuously formed during the polycondensation reaction and has to be eliminated from the reaction solution.

nA-A+mB—B→(A-B)n or m
where A,B=reactants
n,m=number of moles(degree of polymerization)

### Scheme 2

### General Condensation Reaction

Stepwise or condensation polymerization is once again identified where the monomer units initially present are nearly all incorporated into larger molecules at an early stage in the reaction. These larger molecules will stay active and continue to join together so that the average molar mass will increase in time, but once the reaction is started, the yield of polymer species is not time dependent. The reaction usually involves two separate monomer species with different but co-reactive groups and most usually, some small molecule like water will be eliminated as each step occurs. The concept of functionality is noteworthy for polycondensation processes, as each monomer molecule typically has at least two reactive functional groups, so that the product of each reaction step is capable of promoting further condensation reactions. Polyesters may be formulated both at low molecular weight for use in high solids compositions and at higher molecular weight and may be hydroxyl and acid functional. In choosing polyols, three factors influence durability. Both steric factors and the “neighboring group” or “anchimeric” effects affect resistance to hydrolysis. Polyesters can be formulated in a similar manner to alkyds by making calculations of average functionality, supplemented by calculation of acid value of gelation using the Stockmeyer method which is well known in the field. The hardness and flexibility of polyesters may be adjusted by either blending “softer” aliphatic dibasic acids with “harder” aromatic acids or by the inclusion in the polyol blend of more rigid cyclic dialcohols instead of “softer” aliphatic polyols.

### High Solids Coatings Resins by ATRP

The development of some high solids acrylic polyols by ATRP as resins for high solids industrial and automotive coatings has been undertaken in the industry.

Such thermoplastic acrylics or HS APO's (high solids acrylic polyols) have been synthesized by ATRP and reported first by Nuplex Resins (formerly Akzo Nobel resins of Coatings), see “Advanced Acrylic and Polyester Polyols for High Solids Urethane Topcoats”, lecture at the European Coatings Show ECS, Apr. 26, 2005. The properties of these ATRP made polymeric resins and coatings were compared with the corresponding Free Radical Polymerization FRP products, as highlighted in the following examples.

The FRP prepared reference binder was 74% solid, has a glass transition temperature Tg

=276K, —OHV=180 mg KOH/g (hydroxyl value), hydroxyl equivalent weight OHEW=311, hydroxyl content=4% on solids, PDI=Mw/Mn=6010/2730=2.2 and ATRP resins were synthesized at a lower range of targeted molar masses.

The molar mass of the ATRP HS coatings resins designed by ATRP were in the range of Mn,th=1500-2500, PDI<1.49, —OHV=149-180 mg KOH/g, Tg=276-296 K.

Both types of resins were compared in a clear-coat formulation, stoichiometricaily cross-linked with isocyanate and catalyzed by a tin salt (DBTDL, dibutyltindilaurate).

The VOC was calculated and determined experimentally after the clear coatings were thinned down to spray viscosity and the pot life time was determined. The experimental and theoretical VOC values were very close, the pot life time were less than 1 h for the ATRP APO's, whereas the reference FRP binder had a pot life time of 1.25 h. The lowest Mn of the ATRP APO's had the longest pot life time of 1.2 h.

The film properties were evaluated by drawing down the coating at 65% NVM on glass, at a wet film thickness WFT of 100 microns. It was concluded that the ATRP APO's had considerably lower dust-dry times than the FRP reference resin (2.5 h as opposed to 7 h), but the tack free times were comparable (more than 8 h) for both types of resins.

The hardness development of a 90 microns WFT film was studied as well, both at ambient temperature and by forced drying (0.5 h at 60° C.). At ambient temperature, the initial drying of ATRP samples is faster, but this effect disappeared at high layer thickness.

It was also concluded that —OHV values below 150 mg KOH/g was not enough for providing acceptable hardness at ambient temperature.

When the clear coats were force dried, the ATRP resins films hardness build-up faster, but after 7 days of aging they were the same. The effect of Mn, Tg and —OHV was minimal in these forced dry conditions.

Other ATRP APO's were also synthesized, with the same —OHV=180 mg KOH/g and Tg=276K, the molar mass was varied and the effects investigated (Mn=1000, 1500, 200, 2500 and PDI=1.28, 1.35, 1.36, 1.35). Clear coatings were formulated and the VOC calculated at spraying viscosity, VOC=384, 362, 390 g/L against 422 g/L for the reference binder. Again, hardness development was faster for all the ATRP APO's, but after 7 days of curing this effect disappeared. Pot life times were again lower for some of the ATRP APO's, the tertiary amine is a synergist with the Sn based catalyst, so they would go off faster.

The Tg of the ATRP APO's was raised to 293K for improving the films hardness for the Mn=1000, 1500 resins formulated at 73-75% solids and PDI=1.38-1.44. VOC and pot life times were evaluated using 0.03% and 0.05% DBTDL catalyst.

The VOC values are under 400 g/L and the pot life time was proportional to the level of catalyst (it varied from 1 h to 3.5 h).

The conclusion was that at equal pot life time, 1.5 h, the VOC is lower for the ATRP APO than for the reference FRP resin and the overall drying performance was better.

In another set of experiments, the same monomer composition and targeted molar mass (Mn=1500) were aimed for two resins, one synthesized by ATRP another one by FRP. Polydispersities were 1.44 and 1.81 for the ATRP and FRP resins respectively, but no real advantage in terms of VOC was determined. Again at equal reactivity (pot life times) the initial hardness development is much faster for the ATRP clear coating, due to the narrower polydispersity.

The final conclusion was that no real advantage in terms of VOC when ATRP is used instead of FRP, it is noticeable though that the drying time/pot life time balance and the initial hardness development was better for the ATRP acrylic polyols.

A few other interesting ATRP publications about controlled radical semibatch (constant rate addition of monomer and initiator) polymerization for the production of solvent borne coatings resins (degree of polymerization of maximum 50 monomer units,

Mn=2000-5000, 70% polymer by weight) are also available now, see the work of M. F. Cunningham, R. A. Hutchinson, in “Atom-Transfer Radical Batch and Semibatch Polymerization of Styrene,” Macromol. React. Eng. 1, 425-439, 2007 and “Semibatch Atom Transfer Radical Copolymerization of Styrene and Butyl Acrylate,” in Macromol. Symp. 259, 151-163, 2007. An example is quoted here from these two papers, in which various polymers made by different techniques and compared afterwards.

First of all, FRP of styrene first at 138° C. was performed, with a targeted molar mass Mn,th<10000 for the polymer, with 2% molar peroxide initiator to monomer, over 6 h constant rate addition of monomer and initiator, with a final weight ratio monomer/solvent=70/30. The product had PDI=1.6 with full conversion reached in 5 h.

When NMP (nitroxide mediated polymerization, another living controlled polymerization technique developed around the so called nitroxy “stable radicals” such as TEMPO tetramethyl piperidinyloxy radical) was employed as a method using the same peroxide (0.3 mol/L) as initiator and 4-OH-TEMPO (0.46 mol/L), the targeted molar mass was Mn,th=5600.

The system exhibited living polymerization characteristics (PDI<1.5, linear dependence between molar mass and conversion), but after 6 h of feeding time, conversion was just 30% and it went to 65% after 8 more hours of heating at 138° C.

ATRP was then pursued with CuBr as catalyst, PMDETA (pentamethyl diethylenetriamine) as ligand and MBrP (methyl bromopropionate) as initiator at 110° C.

Reaction mixture: Sty/CuBr/PMEDTA/MBrP=50/1/1/1 which means Mn,th=5200. The feeding time was also 6 h, conversion reached was 50%, after 4 more hours it reached to 90%. It was noticed that molar mass increased linearly with conversion, PDI<1.5, but initiator efficiency f=Mn,th/Mn,exp=0.42 was quite low. The amount of CuBr catalyst was reduced and the initiator efficiency was increased, without affecting the molar mass at all, which is a very helpful finding, considering that the major limitation of ATRP is the removal of copper catalyst from the final polymer.

Solvent free dispersions were pursued via ATRP by BASF, see the patent WO 0039169, involving the monomer 1,1-diphenylethylene, DPE (CH₂═C-Ph₂) in a two-step process. First, a water soluble DPE containing oligomer is synthesized which has highly reactive bonds due to the DPE species—these are available for further free radical attack. In a second step, other monomers are inserted into the labile DPE bond thus generating specific polymer architectures.

Polyester Coatings Versus/and Acrylic Coatings

Both acrylate and polyester resins have strengths and weaknesses when formulated into coatings. The advantage of acrylic resins is their high weather resistance which is expressed by high gloss retention with no chalking and no yellowing. Their weakness is usually their visual appearance because they give poorer leveling and brilliance than polyester resins when formulated into both water- and solvent-based coatings.

Polyester resins are often used due to their excellent optical appearance, good drying behavior and smooth handling in production. They have poorer weather resistance compared to the acrylate resins, but that is good enough in most of the cases.

A need therefore exists to provide a high solids coating composition having low VOC which overcomes or mitigates at least one of the problems associated with current coating compositions.

### SUMMARY OF THE INVENTION

Low VOC siliconated high solids coating compositions are provided. The coating compositions comprise a resinous polymer having a siliconated hydroxyl functional acrylic and/or polyester copolymer. The coating compositions further comprise a hardener selected from a polyisocyanate or an amino resin cross-linking agent. The resinous polymer may optionally comprise a solvent in an amount of up to 30%. The copolymers may be made by specialized FRP, ATRP or polycondensation reactions or various combinations thereof as necessary to obtain the desired copolymer.

The polymers designed and synthesized by various methods, such as those described herein, achieve low molar mass and narrow polydispersity, which means low viscosity application for the low VOC high solids coating compositions formulated once the curing agent and other optional coating additives are added. Curing of the coatings may be achieved by chemical reaction with polyisocyanates of low viscosity and high solids content or by baking in the presence of an amino resin cross-linker and a catalyst.

In one illustrative embodiment there is provided a low VOC siliconated high solids coating composition comprising:
i) a resinous polymer comprising: a siliconated hydroxyl functional acrylic and/or polyester copolymer; and
ii) a hardener selected from a polyisocyanate or an amino resin cross-linking agent.

In further illustrative embodiment of the coating composition the copolymer has a number average molecular mass Mn of between 1,000 and 20,000 and a hydroxyl content in solid polymer of —OH %=3-10%.

In further illustrative embodiment of the coating composition the number average molecular mass Mn is between 2,000 and 10,000.

In further illustrative embodiment of the coating composition the resinous polymer further comprises between 0% and 30% of a solvent and between 70% and 100% of the solid copolymer.

In further illustrative embodiment of the coating composition, the composition further comprises at least one of:
iii) an active pigment;
iv) an additive;
v) a filler; and
vi) a coating composition solvent.

In further illustrative embodiment of the coating composition the coating composition solvent is present in an amount of greater than 0% to 10% by weight.

In further illustrative embodiment of the coating composition the polyisocyanate is present in a curing ratio of hydroxyl content of polymer to active group of hardener —OH:—NCO of 0.8 to 1.5.

In further illustrative embodiment of the coating composition the amino resin cross-linking agent is present in a curing ratio of polymer to amino resin of 1:1 to 20:1 by weight.

In further illustrative embodiment of the coating composition high solids coating composition has a composition of at least 50% solids by weight before application.

In further illustrative embodiment of the coating composition the copolymer is an acrylic copolymer prepared by free radical polymerization (FRP) process, wherein the FRP process comprises:
a) a monomer mixture comprising monomers selected from the group consisting of methacrylic, acrylic, vinyl and allyl wherein at least one of the methacrylic or acrylic monomers comprises a hydroxyl functional group and at least one of the methacrylic or acrylic monomers optionally comprises a silane/siloxane functional group;
b) an initiator;
c) a chain transfer agent optionally including a silane/siloxane functional group; and
d) a solvent;
wherein at least one of the monomers or the chain transfer agent comprising a silane functional group.

In further illustrative embodiment of the coating composition the monomer mixture comprises:
i) between 30% and 70% by weight non-functional monomers; and
ii) between 30% and 70% by weight functional monomers;
wherein the functional monomers comprise 5 to 45% by weight hydroxyl substituted monomers and 1 to 40% by weight silane/siloxane (meth)acrylic monomers.

In further illustrative embodiment of the coating composition the initiator is present in an amount of between 1% and 4% by weight relative to the monomer mixture or in an amount of between 0.5% to 3% molar to the monomer mixture and the chain transfer agent is present in an amount of between 1% and 12% by weight relative to the monomer mixture or 0.2 and 10% molar relative to the monomer mixture.

In further illustrative embodiment of the coating composition the chain transfer agent is a mercaptan having the general formula —RSH, wherein R represents an substituted or unsubstituted alkyl group, optionally substituted with a silane/siloxane, amino or alcohol group and wherein the alkyl group is optionally an oligomeric alkyl substituted group having a molecular weight of up to 9,000.

In further illustrative embodiment of the coating composition the copolymer is an acrylic copolymer and is prepared by atom transfer radical polymerization (ATRP) process, wherein the ATRP process comprises:
a) a monomer mixture comprising monomers selected from the group consisting of methacrylic, acrylic, vinyl and allyl wherein at least one of the methacrylic or acrylic monomers comprises a hydroxyl functional group and at least one of the methacrylic or acrylic monomers comprises a silane/siloxane functional group;
b) a catalyst selected from a transition metal salt;
c) a ligand for coordinating to the catalyst to form a complex;
d) an initiator selected from an alkyl substituted halide, arene sulfonyl chloride or thyocyanate and wherein the halide atom is Br or Cl; and
e) a solvent.

In further illustrative embodiment of the coating composition the monomer mixture comprises:
i) between 30% and 70% by weight non-functional monomers; and
ii) between 30% and 70% by weight functional monomers;
wherein the functional monomers comprise 5 to 45% by weight hydroxyl substituted monomers and 1 to 40% by weight silane/siloxane (meth)acrylic monomers.

In further illustrative embodiment of the coating composition the catalyst is a salt of Ruthenium, Iron, Nickel, Rhodium or Copper.

In further illustrative embodiment of the coating composition the catalyst is like Cu(I)Br or Cu(I)Cl.

In further illustrative embodiment of the coating composition the catalyst is a salt of Copper selected from triflates, carboxylates or hexafluorophosphates.

In further illustrative embodiment of the coating composition the ligand is selected from a Schiff base or a multidentate amine.

In further illustrative embodiment of the coating composition the initiator is a halide of a silane or a siloxane.

In further illustrative embodiment of the coating composition the catalyst and the ligand are embedded onto the same solid support.

In further illustrative embodiment of the coating composition the catalyst level employed is from 1% molar to 0.1% molar to the monomer mixture, the ligand to catalyst molar ratio is from 1:1 to 2:1 and the initiator to monomer mixture molar ratio is from 1:5 molar to 1:100 molar based on the molar mass of copolymer and formula weight of each monomer.

In further illustrative embodiment of the coating composition the copolymer is an acrylic polyester copolymer and is prepared by atom transfer radical polymerization (ATRP) process, wherein the ATRP process comprises:
a) a monomer mixture comprising monomers selected from the group consisting of methacrylic, acrylic, vinyl and allyl wherein at least one of the methacrylic or acrylic monomers comprises a hydroxyl functional group and at least one of the methacrylic or acrylic monomers comprises a silane functional group;
b) a catalyst selected from a transition metal salt in its lowest state of oxidation;
c) a ligand for coordinating to the catalyst to form a complex;
d) an initiator comprising a polyester halide, with or without silane/siloxane functionality, wherein the halide atom is Br or Cl; and
e) a solvent.

In further illustrative embodiment of the coating composition the resinous copolymer comprises siliconated acrylic polyols prepared by FRP or ATRP blended with polyester polyols in a ratio of between 1:99 to 99:1 by weight.

In further illustrative embodiment of the coating composition the polymer is a polyester polyol with silane/siloxane functionality used on its own or blended in a ratio of between 1:99 to 99:1 by weight with polymers made by ATRP or FRP.

### DETAILED DESCRIPTION

It is desirable to combine the good weathering properties of the polyacrylates with the outstanding visual appearance of the polyesters and so the combination by synthesis of the hydroxyl-polyacrylates and carboxyl-terminated polyesters. This combination has demonstrated to have synergistic effects, bringing out the properties of the two types of materials in a single type of polymer.

Acrylic polyols, polyester polyols and acrylic-polyester polyols with silicone and other functional groups (amino, polyester, oxirane, allyl) in the backbone or side chain are described herein and may be synthesized by, for example, Free Radical Polymerization (FRP), Atom Transfer Radical Polymerization (ATRP) and/or polycondensation reactions and used as such or blended in different proportions in order to formulate a resinous polymer for a clear or pigmented high solids coating with low VOC by curing with polyisocyanate hardeners or amino resins cross-linkers.

The illustrative hydroxyl functional acrylic and/or polyester (co)polymers may have the following characteristics: a number average molecular mass Mn=1000-20000, preferably 2000-10000 and polydispersity index PDI<2-3; glass transition temperature Tg=−50° C. to 50° C.; hydroxyl equivalent weight OHEW=200-500, which corresponds to a hydroxyl content on solid polymer of —OH %=3-8%.

These polymeric resins made according to the current invention can be employed for formulating various high solids coatings with or without organic solvents. The components of such high solids coatings may be formulated with the current polymeric materials described herein and may optionally further include conventional cross-linking agents, catalysts, antioxidants, flow promoters reactive diluents, surface modifiers, UV absorbers, as well as pigments and/or fillers as necessary for the various application and/or synthesis method.

The coatings thus prepared with the resinous copolymers can be applied to a variety of substrates, using conventional methods known in the art, such as spray coating through the nozzle of a spray gun, roller coating, dipping, brushing and electrostatic application. A small amount of solvent can be employed for lowering the viscosity of the resin and cross-linking agent mixture, in order to counteract the viscosity increase generated by the chemical curing reaction (longer pot life time). The substrates to which the coating compositions can be applied may be, for example, metal, wood, glass and plastics such polystyrene, polyurethane and copolymers of styrene.

The thus-formed coatings may be air dried or baked and the resulting coating may be 10-100 microns thick (once it is dried), preferably 30-60 microns thick after drying and can be polished or rubbed by conventional techniques, if desired, to improve smoothness or apparent gloss of the film or both.

Monomers employed in the FRP and ATRP processes may be “hard” or “soft” copolymers (after the Tg of their homopolymers), can be functional or non-functional and may be procured from commercial sources or synthesized from commercially available intermediates.

Terpolymers, tetrapolymers and pentacopolymers were synthesized by employing the monomers and using the two methods FRP and ATRP and variations of them.

The polymers may be random, alternant, grafted, block or gradient copolymers and may adopt various shapes from linear to nonlinear and/or multi arm stars.

The FRP and ATRP reactions may be mainly carried out in organic solvent solutions or in bulk, but the reactions can also be performed in suspension, emulsion or miniemulsion by employing other developed living controlled polymerization techniques that have been emerging lately and are available.

The monomers employed may be categorized as vinyl, acrylic, methacrylic and allyl monomers.

### A. Polymers Made by Free Radical Polymerization

The vinyl monomers employed for free radical solution polymerization are mainly, but are not limited to, vinyl aromatic monomers containing 8 to 12 Carbon atoms and their halogenated substituents, such as styrene, alpha methyl styrene, chlorostyrene, 4-vinyl pyridine and vinyl toluene. Vinyl chloride, vinyl acetate, acrylonitrile could also be used, again mainly for free radical polymerization reaction. Vinyl monomers with alkoxy- or alkyl-silane groups were also employed in solution FRP reactions, such as vinyl triethoxysilane or vinyl trimethoxysilane.

The (meth)acrylic monomers employed in the experimental part of the current disclosure can be subdivided into the following categories:
a. non-functional, with alkyl substituents CH₂═CH(R)—COOR′, with R═H or Methyl and R′═C₁-C₁₂, aliphatic, cyclic or aromatic, where all or some of the Carbon atoms can be primary, secondary or tertiary substituted. They are mainly esters of (meth)acrylic acid and mostly preferred are the C₁-C₄ esters of monhydric alcohols or (meth)acrylic acid such as methyl (meth)acrylate, ethyl (meth)acrylate, propyl (meth)acrylate, butyl (meth)acrylate, tert butyl (meth)acrylate. Environmentally friendly monomers were also synthesized from commercially available hydroxyl substituted vegetable oils by reactions with (meth)acryloyl chloride in the presence of a base, generating (meth)acrylic monomers with vegetable oil side chains.
b. functional, with the following moieties:
   hydroxyl, the preferred and illustrative monomers are hydroxyl-substituted alkyl (meth)acrylates like hydroxyethyl (meth)acrylate HEA or HEMA, hydroxypropyl (meth)acrylate HPA or HPMA, although we were not restricted from using other substituted hydroxyl (meth)acrylate such as chlorohydroxypropyl (meth)acrylate, dihydroxypropyl (meth)acrylate. Although one of ordinary skill in the art will recognize that many different hydroxyl-substituted alkyl (meth)acrylate including those listed here can be used, the preferred hydroxyl functional monomers for use in the resin of this invention are hydroxyl substituted (meth)acrylate, meaning alkyl (meth)acrylate having a total of 5 to 7 carbon atoms, i.e. the esters of C₂-C₃ dihydric alcohols and acrylic or methacrilic acid.
   carboxyl, such as (meth)acrylic acid, but only for ATRP, because they cannot be polymerized by ATRP due to their interaction with the nitrogen atoms of the ligand that can be protonated (they can be deprotected via hydrolysis from tert butyl groups coming from the corresponding acrylate or methacrylate polymerized by ATRP)
   oligoethyleneglycol (meth)acrylates (synthesized in house from methacryloyl chloride and alkoxy terminated polyethylene or polypropylene glycols)
   oxirane such as glycidyl methacrylate or other glycidyl esters, which will impart the superior properties of epoxy polymers (mainly chemical resistance) to the final resins
   amino functional (meth)acrylic monomers may also be used, the preferred ones are dialkylaminoethyl (meth)acrylates, with methyl or Ethyl as the preferred alkyl groups. Monomers with amino functionality were also synthesized (and the copolymerized) by reacting (meth)acryloyl chloride with amino alcohols (such as aminoethanol or AMP 95 of Angus Chemicals) in the presence of a base (triethyl amine is preferred)
   silane (meth)acrylates optionally as commercially available products, with alkoxy or alkyl substituents (which makes the polymers susceptible or not to reactions with other hydroxyl groups coming from water or from hydroxyl substituted monomers incorporated into the polymer. In the first case, when the alkoxy substituents of the silane monomer can react with other hydroxyl groups present in the reaction solution, moisture scavengers are employed in different proportions, in order to keep the reaction under control and the viscosity of the final polymeric solution within acceptable limits upon storage).

The general formula for the silane (meth)acrylates employed is

CH₂═CHR—COOR′—SiR″₃

where R═H, Methyl; R is an alkyl spacer with at least 3 C atoms and R″ is an alkoxy or alkyl group with 1-3 C atoms.

Other oligomeric silane methacrylates may be synthesized and polymerized by reacting methacryloyl chloride with various polyolygoethylene glycol mono- or poly-substituted silanes or oligomeric siloxanes in the presence of a base, to provide silane or siloxane mono- or -polyoligoethylene substituted (meth)acrylates.

Another group of hydroxyl substituted silane methacrylates may be synthesized, for example according to patent application publication US 2003/0236376 and U.S. Pat. No. 4,235,985 by reacting (meth)acrylic acid or hydroxyl substituted (meth)acrylates with molecules such as X-Sp-SiR3, where X is a cross-linker such as —Cl, —NCO, glycidyl or —COOH; Sp-is an alkyl spacer with 3-5 C atoms in the chain and R is an alkoxy or alkyl substituent for the Si atom.

The allyl monomers of general formula CH₂═CH—CH₂—OR where employed and are basically allylic alcohols selected from the group consisting of allyl alcohol, ethoxylated allyl alcohols of 1 to 5 oxyethylene units, propoxylated allyl alcohols of 1 to 5 oxypropylene units and mixture of those.

Initiators employed in the FRP process play an important role in determining the final properties of high solids coatings resins. The most widely used classes of initiators in free radical polymerization are the so called “thermal initiators”, the most important in this class being azo initiators (—N═N—) and peroxides (—O—O—), within each class there are differences with regard to decomposition temperature and the half life time of these initiators (the time in which half of the amount of initiator is decomposed at a certain temperature and is available for propagation reactions). The chemical nature and structure of the initiator and the polymerization reaction conditions were found to influence the efficiency of the polymerization and the final resins properties. Once the initiator selection was properly made, the acrylic high solids coatings resins exhibited low molecular weight, narrow molecular weight distribution, low viscosity and reduced volatiles.

The initiators of choice giving the best results in the synthetic work of the current invention were mostly peroxides, preferably tertiary alkyl peroxides, like peroxyesters, peroxyketals and dialkyl peroxides (mainly di-tert-butyl and di-tert-amyl peroxide).

Other peroxides have also been employed such as tert-amyl peroxy-2-ethylhexanoate; 1,1-di-(tert-amylperoxy)cyclohexane, tert-amyl perbenzoate, tert-amyl peroxyacetate; 2,2-di-(t-amylperoxy)propane, ethyl 3,3-di(tert-amylperoxy)butyrate.

Azo initiators were also employed, but their initiator efficiency and effect over the final properties of the polymer where somewhat lower than most of the peroxide initiators employed at equal concentrations, but this can be explained by the different decomposition rate at similar temperatures. The most important azo initiator employed in this work was azo-bis-isobutyronitrile or AIBN (despite its solid nature and poor solubility, it has non-grafting characteristics), but other commercially available azo initiators can also be employed (sold by DuPont under the trade name VAZO™).

The amount of initiator employed in the FRP reactions for the synthesis or acrylic, allyl and vinyl polymers, reported to the monomer mixture, varied between 1% and 4% by weight or 0.5% to 3% molar, at reaction temperatures between 80° C. and 150° C.

Chain transfer agents CTA's have the role of regulating the growth of the polymer chains thus leading to lower molar masses of the polymeric materials. They will prevent or retard the propagation step and the chain transfer reaction with the polymer, monomer and/or solvent.

The most widely used CTA at industrial level are the so called mercaptans with the general formula RSH, where R can be any substituted alkyl group, preferably with amino, alcohol and silane functionality for the purpose of the invention. Commercially available oligomeric silane mercaptans with molar masses between 2000 and 9000 were also preferred, due to their efficiency, high silicone content, low odour and low sulphur content (they have a content of mercaptan groups in the molecule of —SH %=1-10% by weight). Combinations of various CTAs were also successfully employed.

Mercaptoalcohols like mercaptoethanol may be also employed for polymer modification reactions of ATRP made polymers which were found to take to purer polymers as the sulphur atoms which will end cap the polymer chains will deactivate the transition metal catalyst by complexation (for example, according to the experimental procedures disclosed in patent application publication WO2008017522).

The level of CTA employed in the FRP reactions for the synthesis or acrylic, allyl and vinyl polymers, reported to the monomer mixture, varied between 1% and 8% by weight or 0.2% to 3% molar, at reaction temperatures between 80 C and 150 C.

Solvents employed in the Free Radical and Atom Transfer Radical Polymerization were mainly chosen from toluene, xylene, butyl acetate, methyl isobutyl ketone, methyl amyl ketone, butyl alcohol and other aliphatic, cycloaliphatic and aromatic hydrocarbons, esters, ethers, ketones and alcohols or combinations thereof. It will be appreciated by one of skill in the art that other solvents may be suitable for carrying out the reactions and synthesis for preparing resinous copolymers as described herein. Some of the reactions may be carried out in the absence of any solvent and 100% solid polymers obtained.

Monomer Mixtures Employed for FRP Processes

An illustrative total monomer mixture utilized in the free radical solution polymerization process comprises (a) from about 30 to 70 weight percent and preferably from about 40 to 60 weight percent of non functional monomer, (b) from about 30 to 70 weight percent and preferably from about 40 to 60 weight percent of functional monomer including at least from about 5 to 30 weight percent of hydroxyl substituted monomer and from 1 to 40 weight percent of silane acrylic or methacrylic monomer.

The amount of initiator employed in the FRP reactions for the synthesis of acrylic, allyl and vinyl polymers, reported to the monomer mixture, may vary between 1% and 4% by weight or 0.5% to 3% molar, at reaction temperatures between 80° C. and 150° C.

The level of CTA employed in the FRP reactions for the synthesis of acrylic, allyl and vinyl polymers, reported to the monomer mixture, may vary between 1% and 8% by weight or 0.2% to 3% molar, at reaction temperatures between 80° C. and 150° C.

The free radical solution polymerization may be carried out with up to 40% of organic solvent present and at temperatures below reflux or at reflux, these temperatures being defined by the solvents employed.

One illustrative method to carry out the polymerization reaction is the one-shot technique where solvent, monomers, initiator, chain transfer agent and other additives (such as moisture scavengers) are heated together until full conversion is reached.

To make sure the reaction is completed, an extra shot of chaser initiator may be added in to finish off the reaction or the temperature is raised by 5-10° C. and the reaction is allowed up to an extra hour of stirring at that temperature. The heat generated during the reaction may be removed with the help of a condenser.

A further way of performing the reaction is the so called “drip feed” method, where premixed monomer, initiator and chain transfer agent is fed into the heated solvent gradually over a period of time up to 3 hours. This method can give better control of the molecular weight and lower polydispersity index. The monomers, initiator and chain transfer agent may also be fed into the main reactor from separate vessels, for ultimate safety purposes. Viscosity solids content of the reaction solutions may be carefully monitored, to monitor the conversion. The main drawback of the FRP process again is that no correction is possible once the reaction has commenced.

### B. Polymers Made by Atom Transfer Radical Polymerization

ATRP is a method that provides a better control than FRP over the final properties of the polymers. It was determined to be useful to synthesize low viscosity acrylic polyols with various functionality, even though the reaction conditions and formulations are more demanding than the conventional FRP. Polymers with similar structures to those described above with regard to FRP may be synthesized, however the molecular mass is lower and the polydispersity index narrower and overall the polymeric solutions exhibit lower viscosities.

Every monomer and combination of monomers may be polymerized by ATRP using the best catalytic and initiating system available. Some reactions may be too slow because of the catalytic and initiating system, as it is known that the technique is “monomer specific”, i.e. no monomer or combinations of monomers can be readily polymerized with any ATRP catalytic system and/or initiator available, even though the technique is tolerant to a wide range of monomers and/or impurities present in the reaction vessel.

Other variations of ATRP reactions were carried out with some success and considered for scaling up, such as AGET ATRP and Reverse ATRP. Monomer line ups employed are not only restricted to the two methods named above.

The general structure of a polymer made by ATRP in the experimental work carried out can be represented as in Scheme 3:

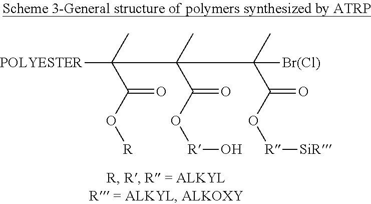

The final polymer may be purified in situ or after separation by employing a variety of purification methods and materials, the final level of transition metal catalyst acceptable for the polymers of the invention is below 100 ppm. A variety of purification methods have been tested and ultimately considered for industrial viability and these include but are not limited to:
passing the final polymer solution through purification columns packed with silica, alumina and/or cation exchange resins.
using the so called “supported recyclable catalysts”, which can be supported on cross-linked polymer beads (such as Wang resins, Jandajel resins), on silica gel or on a linear polyethylene oligomer (soluble in the reaction medium at the polymerization temperature, but insoluble at room temperature upon cooling).
performing the reactions in ionic liquids
by adding a fluorinated liquid compound to dissolve the transition metal catalyst, the liquid being miscible with the reaction mixture at elevated temperatures, but separated quickly at room temperature and the catalyst may be separated and recycled with polymer yields of up to 60%.

The polymers made by ATRP may have the same functionalities in the side chains or in the backbone, but are end capped with a halogen atom (Pol-Br) and may be modified by post reacting them in situ or after they are separated, in order to change some of their chemical functions and obtain polymers with the general structure Pol-Y, Y aminoalcohol, silyl, amine, vinyl, mercaptoalcohol etc).

Another modification reaction successfully performed is that of hydroxyl polymers made by ATRP (represented generally as Pol-OH), by the reaction with alkyl substituted chlorosilanes of general formula SiR₄-nClₙ in the presence of a base, to lead to polymers with alkyl silane functionalities Pol-OSiR₃ (see Macromolecules 1999, 32, pg 8760)—see Scheme 5. The hydroxyl groups present in the side chains of the copolymers may be fully substituted with non-hydrolyzable mono- or polyalkyl substituted silanes, but a partial substitution of the hydroxyl groups with alkyl silanes is also accomplished by reacting the hydroxyl groups from the ATRP polymer with a less than equimolar amount of the SiR₄-nClₙ; now the polymer will have a reduced level of hydroxyl cross-linking sites and a certain level of silane functionality. The SiR₄-nClₙ compound preferred for this reaction is trimethylchloro silane, but dimethyldichlorosilane and methyltrichloro silane can also be employed.

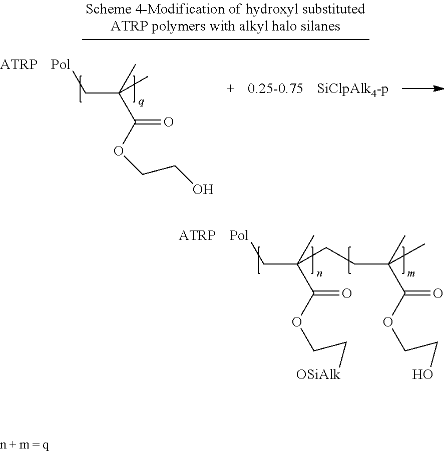

Some of the ATRP polymers of the current invention have been purposely designed as low viscosity materials with very high hydroxyl and/or silicone content, so they can be employed as reactive diluents by blending with other polymers made either by FRP, ATRP and/or polycondensation.

Some of the monomers (described above), ligands, initiator, catalysts and supported recyclable catalysts employed in ATRP reactions for the synthesis of the targeted (co)polymers may been synthesized or may also be selected from the wide range of commercially available products, for example, as follows:

ATRP catalysts—are mainly transition metal salts, the most preferred for the purpose of the invention are copper halides such as Cu(I)Br and Cu(I)Cl. The range of catalysts that can be employed are salts of Ruthenium, Iron, Nickel, Rhodium and/or other salts of copper such as triflates, carboxylates or hexafluorophosphates.

ATRP ligands—the selection of the ligands was carefully performed, as it influences the solubility of the transition metal catalyst (the higher the solubility, the more homogeneous the reaction mixture and the higher the activity of the catalyst) and also stabilizes the lower or upper oxidation state of the catalyst.

Illustrative ligands are the Schiff bases and/or multidentate amine ligands, commercially available or synthesized in house.

The commercially available ATRP ligands employed with copper based catalysts were from the bipyridine and alkyl substituted bipyridines class (such as dinonyl bipyridine) or other aromatic bidentate nitrogen ligands such as phenanthroline, but also from the class of multidentate amine ligands such as PMDETA, TMDETA, HMTETA, HMTREN or others which are known to those skilled in the art.

Ligands for ATRP may also be synthesized in the laboratory and employed in the polymerization reactions. The synthesized ligands may be from the imines class, represented as RCH═NR' and obtained by reacting aldehydes of the general formula RCHO (where R mainly stands for pyridine or bipyridine) with various substituted amines R′NH2 (R′=alkyl or substituted alkyl) or even amino functionalized polymers Pol-NH2, made by ATRP as Pol-Br and subsequently modified with various amines.

For other transition metal salts employed as catalysts, such as salts of Ni, Rh, Ru, Fe or Re, the ligand of choice is, but it is not restricted to, triphenyl phosphine Ph₃P.

ATRP supported recyclable catalysts may be synthesized and employed through various methods, the most convenient is the one pot, two step reaction involving the reaction between the aldehyde, the copper transition catalyst and the substituted amine, for example, by following the experimental methods of WO0052061. The final powders obtained were analyzed for copper content and found to be closed to the theoretical values given by the calculations performed prior to the reaction. When the polymerization reactions are then performed, polymer yields may be higher than 75%, the polymers can have less than 0.1% by weight residual copper and the recovery yield of catalyst may never be below 60%.

Commercially available materials such as Jandajel resins with amino functionality can also be used to immobilize the copper catalyst once reacted with an amine and after the polymerization reaction the catalyst ligand complex may easily be removed.

ATRP initiators—an efficient initiator should mimic the structure of the chain end of the dormant polymer species. The ATRP initiators of choice are from the class of alkyl halides, mainly chlorides and bromides, with activity substituents on the alpha C atom, such as carbonyl, aryl, cyano. Arene sulfonyl chlorides are also employed (like tosyl chloride) and other initiators that can be employed are carbon tetrachloride and thyocyanates (pseudohalogens).

ATRP initiators may be made according to the synthetic procedure outlined in WO0052061 starting from bromoisobutyryl bromide and other similar compounds by reacting them with various commercially available alcohols, hydroxyl functional oligomeric or non-oligomeric silanes and/or siloxanes or amines.

Polyesters with bromine functionality can be synthesized according to U.S. Pat. No. 6,124,411, with molar masses below 5000 and employed as macroinitators for the synthesis of polyester acrylic polyols with molar masses below 10000.

Monomer Mixtures Employed for ATRP Processes

The total monomer mixture utilized in the free radical solution polymerization process may comprise (a) from about 30 to 70 weight percent and preferably from about 40 to 60 weight percent of non functional monomer, (b) from about 30 to 70 weight percent and preferably from about 40 to 60 weight percent of functional monomer including at least from about 5 to 30 weight percent of hydroxyl substituted monomer and from 1 to 40 weight percent of silane acrylic or methacrylic monomer.

The amount of transition metal catalyst, ligand and initiator employed in the ATRP reactions for the synthesis or acrylic polymers, reported to the monomer mixture, may vary between different levels according to the targeted degree of polymerization and the type and chemical nature of each of these three components, at reaction temperatures between room temperature and 150° C. The degree of polymerization is given by the molar ratio between the monomer and the initiator and the catalyst level optimized, in the sense that several times less and less catalyst can be employed and the effects over the reaction rate and final polymer molar mass and polydispersity are not detrimental.

The catalyst level employed varies from 1% molar to 0.1% molar to the monomer mixture and the ligand to catalyst molar ratio may be from 1 to 1 or 2 to 1.

The initiator level, reported to monomer mixture varies from 1 to 5 molar to 1 to 100 molar, depending of the molar mass of the targeted polymer and the formula weight of each monomer.

The solution ATRP reactions may be carried out with up to 40% of organic solvent present and at temperatures below reflux or at reflux, these temperatures being defined by the solvents employed.

One way to carry out the a random ATRP polymerization reaction is the following: the solid transition metal catalyst is charged first into the reactor, then the ligand (to create the complex upon stirring), then the monomers (full amount or part thereof, if a gradient copolymer is targeted) and then the initiator may be added last, after the solvent and after the reaction temperature is reached.

When a block copolymer is targeted, the first monomer is polymerized and the polymer separated and employed as a macroinitiator for the second or third monomer polymerization.

Viscosity solids content of the reaction solutions should be carefully monitored, to monitor the conversion and the reactions are stopped if the control is not very good in the initial stages.

### C. Polyester Polyols Made by Polycondensation

Polyester polyols with silicone functionality may be synthesized in one or two step reactions at elevated temperatures, in the presence of transition metal catalysts and also cured with commercially available polyisocyanates and/or amino resins cross-linkers.

In the polyesters for high solids coatings the total polyol in the composition may be increased and the resin processed to lower molecular weight and higher hydroxyl content for proper cure with polyisocyanate and/or amino resin cross-linkers.

For polyesters the general preparation techniques used in alkyd manufacture may be employed, in two or even one synthetic step at elevated temperatures, but with refinements appropriate to the materials used. All-solid initial charges will arise with many formulations requiring careful melting. Catalysts may be used to increase the reaction rate in high solids polyester polyols preparation, tin catalysts are the main choice, although care must be taken because the catalyst may adversely affect the color of the final dry paint film. Silicone modification may employed as shown in the experimental section to enhance the final durability of the polyester resin.

Mono or multifunctional alcohols, difunctional acids and anhydrides are reacted together at high temperatures, with an excess of alcohol, once the reaction is designed at a certain level of hydroxyl functionality excess. Silanol intermediates are also included in the reaction mixture in various proportions in order to impart silicone functionality to the final product.

Once separated, the polyester polyols may be used on their own to formulate clear or pigmented coatings or are blended with FRP or ATRP made acrylic polymers for the same purpose.

### D. Curing of Polymers

The polymers made by FRP, ATRP, polycondensation reactions and all their combinations thereof are formulated into clear or pigmented two pack coatings by using other solvents, additives and pigments (inert or active) and then cured by chemical and/or physical cross-linking with isocyanate hardeners and/or amino resins cross-linkers.

The curing ratios in both cases are stoichiometric, but under- and over-cross-linking curing reactions are also designed with higher and/or lower than necessary level of cross-linker, in order to determine the potential benefits or disadvantages exhibited by the final cured films.

The cross-linking component is ideally a low viscosity and high solids polyisocyanate or an amino resin cross-linker (at elevated temperatures).

The polyisocyanate hardener (effectively a cross-linker that reacts with hydroxyl groups), aliphatic or aromatic, preferably aliphatic (as they provide better exterior weatherability and color stability in the finished coating) and can be chosen from a variety of commercially available hardeners such as toluene diisocyanates, isocyanurates of toluene diisocyanate, diphenylmethane 4,4′-diisocyanate, isocyanurates of 4,4′-diisocyanate, isophorone diisocyanate and corresponding isocyanurates, 1,6-hexamethylene diisocyanate and corresponding isocyanurates, metaxylene diisocyanate, p-phenylene diisocyanate.

Isocyanate-terminated adducts of diols (such as ethylene glycol or butylene glycol) or of hydroxyl substituted acrylic polymers can also be employed and these are formed by reacting more than one mole of an isocyanate with one mole of a diol to form a longer chain isocyanate. Other multifunctional isocyanates may also be employed such as 1,2,4-benzene triisocyanate and polymethylene polyphenyl isocyanate. Derivatives of polyisocyanates, such as biurets, isocyanurates, allophanates, uretdiones and other prepolymers of polyisocyanates can be employed for curing the hydroxyl functional acrylic or polyester polyols of the invention.

For the above mentioned isocyanate based cross-linkers, catalysts can be used for a faster reaction with the hydroxyl groups of the polyol and these catalysts include, but are not limited to, dibutyl tin oxide, dibutyl tin dilaureate, tin catalysts and tertiary amines.

The curing ratio between the hydroxyl and isocyanate groups employed when the polymers of the invention are cured is —OH/—NCO=0.8-1.2, at a total solids content higher then 60% by weight.

The amino resins cross-linkers are complex mixtures with different functional sites and molecular species synthesized through the condensation of formaldehyde with an amine and the subsequent alkylation of the resulting methylol groups with an alcohol. The amino cross-linkers employed for bake curing the polymers are commercially available materials in the form of highly or partially methylated or butylated melamines, alkylated ureas, benzoguanamines or glycouril cross-linkers (having primarily methoxymethyl functional sites), which react with polyols at temperatures above 100° C. with the help of acid catalysts (strong and weak, with pKa<1 and pKa>2 respectively), which improves the flexibility of the cured film.

Urea-aldehyde, benzoguanamine aldehyde or melamine-aldehyde condensation products and the like are mostly preferred, but particularly desired are the polymethoxymethyl melamines, preferable hexamethoxymethyl melamines. It is preferred to employ acid catalysts with the melamine-formaldehyde or urea-formaldehyde curing agents. Some of the desired catalysts are paratoluene sulfonic acid, naphthalene sulfonic acids, naphthalene disulfonic acids and dodecyl benzene sulfonic acids and amine salts of them, as described in, for example, U.S. Pat. No. 4,075,176.

When curing the polymers with the melamine type cross-linker for baking in the oven, the ratio of polymer blend to melamine may be within the range of 1/1 to 20/1 by weight.

The fully dried and cured clear and pigmented films exhibit good chemical, physical and mechanical properties.

The stability over time of the polymeric solutions (known to the ones as Component A or Part A of the coating system, the hardener solution separately delivered is known as Component B or Part B) should also be carefully monitored and corrected, especially when silane (meth)acrylate monomers substituted with hydrolysable alkoxy group are present in the polymerization formulation.

The level of moisture scavenger (an orthoformate or an alkyl alkoxy silane) required to provide a long shelf life time of the polymer may be carefully adjusted to 1-3% by weight on total polymer solution.

### TEST EXAMPLES AND DATA

Number average molecular weights Mn and weight average molecular weights Mw were determined by gel permeation or size exclusion chromatography, with a polystyrene standard, using a WYATT TECHNOLOGY GPC instrument, fully equipped with a UV detector Agilent 1100 series and a separating column from Polymer Laboratories, packed with 5 micron polystyrene beads.

The solids content measurements were carried out by blending the polymer solution with 5-10% toluene or acetone by weight, then by casting a thin film which was baked for 3 h in the oven at 110° C., followed by weighing of the residual material.

### Example 1

In a 250 mL two neck round bottom flask the following was added in order at room temperature, under a nitrogen gas blanket, with constant stirring: CuBr (570 mg, 4 mmol), bipyridine (1.25 g, 8 mmol) and toluene (43 g). The solution turned brown from green and the monomer was added in, methacryloyloxypropyltrimethoxy silane MPTMSi (100 g, 400 mmol). Nitrogen gas was bubbled through the reaction solution for 5-10 minutes and then initiator 2-ethylbromoisobutyrate 2EBIB (7.8 g, 40 mmol) was added into the flask and the temperature was set at 90° C. and the flask was sealed under nitrogen gas. After 6 hours of stirring at 90° C., the reaction was stopped and the polymer solution was taken up in acetone (200 mL) and eluted twice through basic alumina.

The polymer PMPTMSi—Br was analyzed by gel permeation chromatography and had a number average molar mass Mn=3025 and a weight average molar mass of Mw=3630, hence the polydispersity index PDI=Mw/Mn=1.2. To improve its stability over time and prevent its reaction with moisture, Additive OF was added into the storage flask (1-3% by weight on polymer solution).

The polymer may be utilized as a macroinitiator for growing block acrylic polymers, thermosetting or thermoplastic, when other functional or non-functional monomers are used as building blocks.

### Example 2

In a 250 mL two neck round bottom flask CuBr (0.3 g, 2 mmol) and toluene (75 g) were stirred at room temperature for a few minutes and then, under a nitrogen gas blanket, with constant stirring, methacryloyloxypropyltrimethoxy silane MPTMSi (19.6 g, 79 mmol) was added in. The ligand bipyridine (0.6 g, 4 mmol) was added into the flask and then nitrogen gas was bubbled through the reaction solution for 5-10 minutes. The initiator, 2-ethylbromoisobutyrate (3.3 g, 17 mmol) was injected into the flask through the side neck, stirring was continued at room temperature for 20 minutes hours before the temperature was set to 90° C. and the flask was sealed under nitrogen gas. After 3.5 hours of stirring at 90° C., the first shot of hydroxypropyl methacrylate HPMA was brought into the flask from a dropping funnel (flushed and sealed under nitrogen gas), a second step after another hour and the last third portion after an extra hour of stirring (HPMA 50.4 g, 350 mmol). The total stirring time at 90° C. was 7 h, then the reaction was stopped, the flask cooled in a water/ice bath, the polymer solution was taken up in acetone (300 mL) and then eluted through basic alumina.

The new gradient copolymer PMPTMSi-grad-PHPMA-Br was analyzed by GPC and had Mn=5300, Mw=6890, PDI=1.3, a hydroxyl content of 8% on solids (determined by ¹H-NMR) corresponding to —OHEW=213.

Additive OF was added to the polymer solution 1-3% by weight on final polymer solution) for preventing the curing reaction of the silane alkoxy groups with the hydroxyl functionalities of the comonomer.

The polymer can be utilized as a macroinitiator for growing block acrylic polymers, thermosetting or thermoplastic, when other functional or non-functional monomers are used as building blocks.

### Example 3

In a 250 mL two neck round bottom flask CuBr (0.14 g, 2 mmol) and toluene (73 g) were stirred at room temperature for a few minutes and then, under a nitrogen gas blanket, with constant stirring, the monomers were added with stirring, as it follows: MMA (1.6 g, 16 mmol), tertBMA (0.4 g, 3 mmol), butyl acrylate BA (28.8 g, 225 mmol), HPMA (25.2 g, 175 mmol) and methacryloyloxypropyltrimethoxy silane MPTMSi (14 g, 56 mmol). The ligand bipyridine (0.3 g, 2 mmol) was added into the flask and then nitrogen gas was bubbled through the reaction solution for 5-10 minutes.

The initiator, 2 ethylbromoisobutyrate (3.1 g, 16 mmol) was injected into the flask through the side neck, stirring was continued at room temperature for 2 hours before the temperature was set to 80° C. and the flask was sealed under nitrogen gas. The solution became dark brown indicating the onset of polymerization. Stirring was continued at 80° C. for 5 hours. The reaction was stopped after that by cooling the flask in an ice/water bath. The polymer solution was taken up in acetone (300 mL) and eluted twice through basic alumina to give a clear polymer solution filtrate which was concentrated under reduced pressure. The polymer solution was stored under a nitrogen blanket and also 2% Additive OF from Borchers was added in for extended shelf life time.

The copolymer PMMA-ran-PtertBMA-ran-PBA-ran-PHPMA-ran-PMPTMSi—Br had Mn,exp=4500, Mw,exp=5600, PDI=1.25 and —OHEW=450.

When the polymer was cured stoichiometrically with Tolonate HDT LV 2 polyisocyanate hardener (100% solids and 23% —NCO by weight) and dried for a week at room temperature, the film thickness over galvanized steel was of about 75 microns, the adhesion was good and the film hardness was F, it could withstand 180 double rub up cycles with MEK and had an impact strength of 120 and 140 lb× in from the front and from the back, respectively.

### Example 4

A 250 mL two neck round bottom flask was fitted with a dropping funnel, in which the following monomers, initiator and chain transfer agent were weighed in order: butyl methacrylate BMA (17.8 g, 125 mmol), hydroxypropyl methacrylate HPMA (10.8 g, 75 mmol) and methacryloyloxypropyltrimethoxy silane MPTMSi (12.4 g, 50 mmol), then mercaptoethanol (2.6 g, 33 mmol) and benzoyl peroxide BPO (75% in water, 0.9 g form of delivery, 2.5 mmol), The temperature in the flask was set to 90° C. and until it reached that value, nitrogen gas was bubbled through the monomer mix in the dropping funnel for a few minutes. The mixture from the dropping funnel was then drip fed into the flask over a period of an hour at 90° C. under a nitrogen gas blanket. After the monomer mix addition was over, stirring was continued for a further hour at the same temperature and the temperature was set at 110° C. After 30 minutes of stirring at 110° C. to complete the reaction, heating and stirring were switched off.

The clear polymer solution PMPTMSi-ran-PHPMA-ran-PBMA-S—(CH₂)₂—OH (having 100% NVM) was then tipped off and analyzed.

It had Mn,exp=18800, Mw,exp=3200, PDI=1.7 and —OHEW=390.

When the polymer was cured stoichiometrically with Tolonate HDT LV 2 polyisocyanate hardener (100% solids and 23% —NCO by weight) and dried for a week at room temperature, the film thickness over galvanized steel was of about 75 microns, the adhesion was good and the film hardness was HB, it could withstand 100 double rub up cycles with MEK and had an impact strength of 100 and 100 lb× in from the front and from the back, respectively.

### Example 5

MAK (4 g, methyl amyl ketone) was charged into a 100 mL two neck round bottom flask and separately, into a dropping funnel, the following monomers, initiator and chain transfer agent were weighed in order: MAK (2 g), mercaptoethanol (2.7 g, 35 mmol), benzoyl peroxide BPO (75% in water, 1 g form of delivery, 2.8 mmol), MMA (3.5 g, 35 mmol), butyl acrylate BA (11.4 g, 89 mmol), hydroxypropylmethacrylate HPMA (21.6 g, 150 mmol) and methacryloyloxypropyltrimethoxy silane MPTMSi (1.1 g, 4.5 mmol). The temperature in the flask was set to 115° C. and until it reached that value, nitrogen gas was bubbled through the monomer mix in the dropping funnel for a few minutes. The mixture from the dropping funnel was then added into the flask over a period of 15 minutes at 110° C. under a nitrogen gas blanket, then a little bit of MAK (3.8 g) was used to wash in the remainder of the undissolved benzoyl peroxide initiator from the dropping funnel. The nitrogen gas supply was kept on only for 20 minutes as after an extra half an hour of stirring at 110° C., the temperature was raised to 120° C. After an hour of stirring at 120° C. to take the reaction to completion, heating was switched off to stop the reaction. The clear polymer solution (80% NVM) was then easily tipped off. The copolymer thus synthesized with the formula PMPTMSi-ran-PHPMA-ran-PMMA-ran-PBA-S—(CH₂)₂—OH had Mn,exp=17500, Mw,exp=36700, PDI=2.1 and OHEW=280 (on solids).

When the polymer was cured with 20% excess of Tolonate HDT LV 2 polyisocyanate hardener (100% solids and 23% —NCO by weight) and dried for a week at room temperature, the film thickness over galvanized steel was of about 75 microns, the adhesion was good and the film hardness was H (as opposed to HB for stoichiometric curing) and it could withstand 100 double rub up cycles with MEK in both cases.

### Example 6

MAK (4 g, methyl amyl ketone) was charged into a 100 mL two neck round bottom flask and separately, into a dropping funnel, the following monomers, initiator and chain transfer agent were weighed in order: MAK (2 g), mercaptofunctional silane (GP367 of GPC Silicones, which contains 5.4% —SH, 16.6 g, 4.6 mmol), benzoyl peroxide BPO (75% in water, 0.5 g form of delivery, 1.5 mmol), MMA (2.4 g, 24 mmol), ethylhexyl acrylate EHA (11.8 g, 64 mmol) and hydroxypropylmethacrylate HPMA (7.2 g, 50 mmol). The temperature in the flask was set to 110° C. and until it reached that value, nitrogen gas was bubbled through the monomer mix in the dropping funnel for a few minutes. The mixture from the dropping funnel was then added into the flask over a period of 15 minutes at 110° C. under a nitrogen gas blanket, then a little bit of MAK (3.6 g) was used to wash in the remainder of the undissolved benzoyl peroxide initiator from the dropping funnel. The nitrogen gas supply was kept on only for 20 minutes as after an extra hour and a half of stirring at 110° C., the temperature was raised to 120° C. After an hour of stirring at 120° C. to take the reaction to completion, heating was switched off to stop the reaction. The clear polymer solution (80% NVM) was then easily tipped off.

The copolymer PHPMA-ran-PMMA-ran-PEHA-“GP367” was analyzed and had Mn,exp=22600, Mw,exp=43000, PDI=1.9 and OHEW=470 (on solids).

When the polymer was cured with stoichiometrically with Tolonate HDT LV 2 polyisocyanate hardener (100% solids and 23% —NCO by weight) and dried for a week at room temperature, the film thickness over galvanized steel was of about 75 microns, the adhesion was good and the film hardness was HB and it could withstand 100 double rub up cycles with MEK, whereas the impact strength of the film was 160 and 120 lb× in from the front and from the back, respectively.

### Example 7

MAK (3.44 g, methyl amyl ketone) was charged into a 100 mL two neck round bottom flask and separately, into a dropping funnel, the following monomers, initiator and chain transfer agent were weighed in order: mercaptofunctional silane (GP367 of GPC Silicones, which contains 5.4% —SH, 6.3 g, 1.8 mmol), benzoyl peroxide BPO (75% in water, 0.18 g form of delivery, 0.5 mmol), MMA (0.9 g, 9 mmol), ethylhexyl acrylate EHA (4.1 g, 22 mmol), butyl acrylate (2.3 g, 18 mmol), lauryl methacrylate LMA (1.4 g, 5.5 mmol) and hydroxypropylmethacrylate HPMA (2.7 g, 19 mmol). The temperature in the flask was set to 110 C and until it reached that value, nitrogen gas was bubbled through the monomer mix in the dropping funnel for a few minutes. The mixture from the dropping funnel was then added into the flask over a period of 15 minutes at 110° C. under a nitrogen gas blanket, then a little bit of butyl acetate (5.9 g) was used to wash in the remainder of the undissolved benzoyl peroxide initiator from the dropping funnel. The nitrogen gas supply was kept on only for 20 minutes as after an extra couple of hours of stirring at 110° C., the temperature was raised to 120° C. After an hour of stirring at 120° C. to take the reaction to completion, heating was switched off to stop the reaction.

The polymer PHPMA-ran-PMMA-ran-PBA-ran-PEHA-ran-PLMA-“GP367” came up as a clear solution (66% NVM) which was easily tipped off. The analyses revealed a molar mass Mn,exp=26300, Mw,exp=46500, PDI=1.8 and OHEW=630 (on solids).

When the polymer was cured with stoichiometrically with Tolonate HDT LV 2 polyisocyanate hardener (100% solids and 23% —NCO by weight) and dried for a week at room temperature, the film thickness over galvanized steel was of about 75 microns, the adhesion was good and the film hardness was HB and it could withstand 125 double rub up cycles with MEK, whereas the impact strength of the film was 130 and 100 lb× in from the front and from the back, respectively.

### Example 8

MAK (7.3 g, methyl amyl ketone) was charged into a 100 mL two neck round bottom flask and separately, into a dropping funnel, the following monomers, initiator and chain transfer agent were weighed in order: mercaptoethanol (4.4 g, 56 mmol), tert amyl peroxyacetate (60% in petroleum distillate and mineral spirits, 0.7 g form of delivery, 2.8 mmol, supplied by Arkema Inc as Luperox 555M60), MMA (4.9 g, 49 mmol), methacryloyloxypropyltrimethoxy silane MPTMSi (1.1 g, 4.4 mmol), butyl acrylate (16.4 g, 130 mmol) and hydroxypropylmethacrylate HPMA (14.4 g, 100 mmol). The temperature in the flask was set to 135° C. and until it reached that value, nitrogen gas was bubbled through the monomer mix in the dropping funnel for a few minutes. The mixture from the dropping funnel was then added into the flask over a period of an hour under a nitrogen gas blanket, then a little bit more MAK (3 g) was used to wash in the remainder of the solution from the dropping funnel. After two hours of stirring at 135° C. heating was switched off to stop the reaction.

The polymer PMPTMSi-ran-PHPMA-ran-PMMA-ran-PBA-S—(CH₂)₂—OH came up as a low viscosity clear solution (80% NVM) which was easily tipped off.

The analyses revealed a molar mass Mn,exp=1930, Mw,exp=2780, PDI=1.4 and OHEW=300 (on solids).

When the polymer was cured with stoichiometrically with Tolonate HDT LV 2 polyisocyanate hardener (100% solids and 23% —NCO by weight) and dried for a week at room temperature, the film thickness over galvanized steel was of about 75 microns, the adhesion was good and the film hardness was F and it could withstand 100 double rub up cycles with MEK, whereas the impact strength of the film was 140 and 120 lb× in from the front and from the back, respectively.

### Example 9

Xylene (33 g) was charged into a 500 mL two neck round bottom flask and separately, into a dropping funnel, the following monomers, initiator and chain transfer agent were weighed in order: mercaptoethanol (10.3 g, 130 mmol), tert amyl peroxyoctoate (2.5 g, 10 mmol, supplied by Arkema Inc as Luperox 575), methacryloyloxypropyltrimethoxy silane MPTMSi (50 g, 0.2 mol), butyl methacrylate (71 g, 0.5 mol) and hydroxypropylmethacrylate HPMA (43 g, 0.3 mol). The temperature in the flask was set to 90° C. and until it reached that value, nitrogen gas was bubbled through the monomer mix in the dropping funnel for a few minutes. The mixture from the dropping funnel was then added into the flask over a period of two hours under a nitrogen gas blanket, then a little bit more xylene (10.5 g) was used to wash in the remainder of the solution from the dropping funnel. After another half an hour of stirring at 90° C., the temperature was raised to 110° C. and stirring was continued for a further hour and finally, heating was switched off to stop the reaction.

The polymer solution of PMPTMSi-ran-PHPMA-ran-PBMA-ran-S—(CH₂)₂—OH

Thus synthesized, having a solids content of 80% was treated with two different moisture scavengers at the same dosage level (3% by weight on total polymer solution) and the viscosity was followed over time (Brookfield viscometer, spindle no 4) in order to assess the efficiency and the need of such additives required for inhibiting/retarding the reaction between the alkoxy substituted silane and moisture or hydroxyl functionality induced by HPMA units present in the chains. It is obvious from the results that moisture scavengers are needed for longer shelf life, unless the polymer solutions are stored under inert gas.

| | | Viscosity (centipoises cP, | | | | | | |
|---|---|---|---|---|---|---|---|---|
| | | Brookfield no 4)) | | | | | | |
| | | | | | | | | 10.5 |
| Number | Description | 0 | 12 h | 24 h | 4 days | 6 days | 8 days | days |
| Polymer-1 | Without moisture | 3324 | 4430 | 4188 | 4000 | 3660 | 3924 | 4500 |
| | scavenger | | | | | | | |
| Polymer-2 | With moisture | 2100 | 2760 | 2616 | 2480 | 2100 | 2360 | 2712 |
| | scavenger 1 | | | | | | | |
| Polymer-3 | With moisture | 1920 | 2540 | 2340 | 2330 | 1930 | 2120 | 2448 |
| | scavenger 2 | | | | | | | |

Moisture scavenger 1 is methyl trimethoxysilane and Moisture scavenger 2 is Additive OF procured from Borchers (trimethylortho formate).

### Example 10

MAK (4 g, methyl amyl ketone) was charged into a 100 mL two neck round bottom flask and separately, into a dropping funnel, the following monomers, initiator and chain transfer agent were weighed in order: mercaptoethanol (2.7 g, 34 mmol), tert amyl peroxyacetate (60% in petroleum distillate and mineral spirits, 0.4 g form of delivery, 1.7 mmol, supplied by Arkema Inc as Luperox 555M60), MMA (2.9 g, 29 mmol), methacryloyloxypropyltris(trimethylsiloxy) silane MA-TSS (2.6 g, 6.2 mmol, traded by Gelest Inc under the name SIM6487.6), butyl acrylate (9.8 g, 77 mmol) and hydroxypropylmethacrylate HPMA (8.6 g, 60 mmol). The temperature in the flask was set to 135° C. and until it reached that value, nitrogen gas was bubbled through the monomer mix in the dropping funnel for a few minutes. The mixture from the dropping funnel was then added into the flask over a period of an hour under a nitrogen gas blanket, then a little bit more MAK (2.7 g) was used to wash in the remainder of the solution from the dropping funnel. After two hours of stirring at 135° C. heating was switched off to stop the reaction.

The polymer P(MA-TSS)-ran-PHPMA-ran-PMMA-ran-PBA-S—(CH₂)₂—OH came up as a very low viscosity clear solution (80% NVM) which was easily tipped off and the viscosity of the solution was constant for more than a month (the alkyl substituents of the silane/siloxane monomer are not reactive).

When the polymer was cured with stoichiometrically with Tolonate HDT LV 2 polyisocyanate hardener (100% solids and 23% —NCO by weight) and dried for a week at room temperature, the film thickness over galvanized steel was of about 75 microns, the adhesion was good and the film hardness was F and it could withstand 160 double rub up cycles with MEK, whereas the impact strength of the film was 130 and 160 lb× in from the front and from the back, respectively.

### Example 11

In a three neck round bottom flask of 250 mL, equipped with a thermometer, nitrogen gas inlet, stirrer with air motor and a water cooled condenser over a trap, the following ingredients were charged in, in the purpose of synthesizing a polyester polyol:

trimethylol propane (20 g, 150 mmol), hexane diol (11.6 g, 98 mmol), phthalic anhydride (14.8 g, 0.1 mol), adipic acid (9.2 g, 63 mmol), hydroxyl functional silicone (supplied by Dow Corning as Z6018 intermediate having a Mn=1200 and PDI=2, with 48% silicone dioxide content; 6 g, 5 mmol), dibutyltin dilaureate catalyst (0.6 g, 1 mmol) and xylene (7 g). The charge was heated slowly to 190 C and stirred for 21 hours at this temperature, with good agitation and nitrogen gas purge, with removal of water. A small amount of xylene (7 g) was used to remove the water azeotropically. The reaction solution was cooled down to 100° C. and 2-ethoxyethyl acetate (30 g) was added to the flask, before it was cooled down to room temperature and the reaction stopped. The polyester was analyzed by GPC and had Mn=23700 and Mw=50170, so the PDI=Mw/Mn=2.1.

The polymer was cured with Tolonate HDT LV2 (stoichiometric amount) and the cast film showed good adhesion onto metal (galvanized steel and aluminum), the film pencil hardness was H, at a dry film thickness of 75 microns and the impact strength was really good too (140 and 160 lb× in from the front and the back, respectively). Resistance to solvents like MEK and gasoline was also quite good.

The polyester polyol was also cured with a melamine formaldehyde curing agent (Cymel 303 LF of Cytec, which is hexamethoxymethylol melamine), in a stoichiometric amount, in the presence of an acid catalyst (1% by weight as supplied to solid polymer dinonylnaphthalene disulfonic acid DNNDSA, 25% active, traded by King Industries under the trade name Nacure 332). The film was applied onto galvanized still at a 75 microns dry film thickness and baked in the oven for 3 hours at 130° C. The film exhibited H hardness, good resistance to MEK (150 double rub cycles) and the impact strength was 100 and 80 lb× in from the front and back, respectively).

The polyester polyol could also be blended in various proportions with polymers of the Examples 2-10 of the current invention and formulated into two pack coatings cured polyisocyanates like with Tolonate HDT LV2 or amino resins cross-linkers to give final clear or pigmented coating films with both acrylic and polyester backbone and very good mechanical, chemical and physical properties.

The present invention has been described with regard to a plurality of illustrative embodiments. However, it will be apparent to persons skilled in the art that a number of variations and modifications can be made without departing from the scope of the invention as defined in the claims.

1. A siliconated coating composition comprising:
i) a resinous polymer comprising: a siliconated hydroxyl functional acrylic and/or polyester copolymer; and
ii) a hardener selected from a polyisocyanate or an amino resin cross-linking agent; said siliconated coating composition having a high solids content and a low volatile organic content (VOC).

2. The coating composition according to claim 1, wherein the copolymer has a number average molecular mass Mn of between 1,000 and 20,000 and a hydroxyl content in solid polymer of —OH %=3-10%.

3. The coating composition according to claim 2, wherein the number average molecular mass Mn is between 2,000 and 10,000.

4. The coating composition according to claim 1, wherein the resinous polymer further comprises between 0% and 30% of a solvent and between 70% and 100% of the solid copolymer.

5. The coating composition according to claim 1, further comprising at least one of:
iii) an active pigment;
iv) an additive;
v) a filler; and
vi) a coating composition solvent.

6. The coating composition according to claim 5, wherein the coating composition solvent is present in an amount of greater than 0% to 10% by weight.

7. The coating composition according to claim 1, wherein the polyisocyanate is present in a curing ratio of hydroxyl content of polymer to active group of hardener —OH:—NCO of 0.8 to 1.5.

8. The coating composition according to claim 1, wherein the amino resin cross-linking agent is present in a curing ratio of polymer to amino resin of 1:1 to 20:1 by weight.

9. The coating composition according to claim 1, wherein high solids coating composition has a composition of at least 50% solids by weight before application.

10. The composition according to claim 1, wherein the copolymer is an acrylic copolymer prepared by free radical polymerization (FRP) process, wherein the FRP process comprises:
a) a monomer mixture comprising monomers selected from the group consisting of methacrylic, acrylic, vinyl and allyl wherein at least one of the methacrylic or acrylic monomers comprises a hydroxyl functional group and at least one of the methacrylic or acrylic monomers optionally comprises a silane/siloxane functional group;
b) an initiator;
c) a chain transfer agent optionally including a silane/siloxane functional group; and
d) a solvent;
wherein at least one of the monomers or the chain transfer agent comprising a silane functional group.

11. The composition according to claim 10, wherein the monomer mixture comprises:
i) between 30% and 70% by weight non-functional monomers; and
ii) between 30% and 70% by weight functional monomers;
wherein the functional monomers comprise 5 to 45% by weight hydroxyl substituted monomers and 1 to 40% by weight silane/siloxane (meth)acrylic monomers.

12. The composition according to claim 10, wherein the initiator is present in an amount of between 1% and 4% by weight relative to the monomer mixture or in an amount of between 0.5% to 3% molar to the monomer mixture and the chain transfer agent is present in an amount of between 1% and 12% by weight relative to the monomer mixture or 0.2 and 10% molar relative to the monomer mixture.

13. The composition according to claim 10, wherein the chain transfer agent is a mercaptan having the general formula —RSH, wherein R represents an substituted or unsubstituted alkyl group, optionally substituted with a silane/siloxane, amino or alcohol group and wherein the alkyl group is optionally an oligomeric alkyl substituted group having a molecular weight of up to 9,000.

14. The composition according to claim 1, wherein the copolymer is an acrylic copolymer and is prepared by atom transfer radical polymerization (ATRP) process, wherein the ATRP process comprises:
a) a monomer mixture comprising monomers selected from the group consisting of methacrylic, acrylic, vinyl and allyl wherein at least one of the methacrylic or acrylic monomers comprises a hydroxyl functional group and at least one of the methacrylic or acrylic monomers comprises a silane/siloxane functional group;
b) a catalyst selected from a transition metal salt;
c) a ligand for coordinating to the catalyst to form a complex;
d) an initiator selected from an alkyl substituted halide, arene sulfonyl chloride or thyocyanate and wherein the halide atom is Br or Cl; and
e) a solvent.

15. The composition according to claim 14, wherein the monomer mixture comprises:
i) between 30% and 70% by weight non-functional monomers; and
ii) between 30% and 70% by weight functional monomers;
wherein the functional monomers comprise 5 to 45% by weight hydroxyl substituted monomers and 1 to 40% by weight silane/siloxane (meth)acrylic monomers.

16. The composition according to claim 14, wherein the catalyst is a salt of Ruthenium, Iron, Nickel, Rhodium or Copper.

17. The composition according to claim 16, wherein the catalyst is like Cu(I)Br or Cu(I)Cl.

18. The composition according to claim 16, wherein the catalyst is a salt of Copper selected from triflates, carboxylates or hexafluorophosphates.

19. The composition according to claim 14, wherein the ligand is selected from a Schiff base or a multidentate amine.

20. The composition according to claim 14, wherein the initiator is a halide of a silane or a siloxane.

21. The composition according to claim 14, wherein the catalyst and the ligand are embedded onto the same solid support.

22. The composition according to claim 14, wherein the catalyst level employed is from 1% molar to 0.1% molar to the monomer mixture, the ligand to catalyst molar ratio is from 1:1 to 2:1 and the initiator to monomer mixture molar ratio is from 1:5 molar to 1:100 molar based on the molar mass of copolymer and formula weight of each monomer.

23. The composition according to claim 1, wherein the copolymer is an acrylic polyester copolymer and is prepared by atom transfer radical polymerization (ATRP) process, wherein the ATRP process comprises:
a) a monomer mixture comprising monomers selected from the group consisting of methacrylic, acrylic, vinyl and allyl wherein at least one of the methacrylic or acrylic monomers comprises a hydroxyl functional group and at least one of the methacrylic or acrylic monomers comprises a silane functional group;
b) a catalyst selected from a transition metal salt in its lowest state of oxidation;
c) a ligand for coordinating to the catalyst to form a complex;
d) an initiator comprising a polyester halide, with or without silane/siloxane functionality, wherein the halide atom is Br or Cl; and
e) a solvent.

24. The composition according to claim 1, wherein the resinous copolymer comprises siliconated acrylic polyols prepared by FRP or ATRP blended with polyester polyols in a ratio of between 1:99 to 99:1 by weight.

25. The composition according to claim 1, wherein the polymer is a polyester polyol with silane/siloxane functionality used on its own or blended in a ratio of between 1:99 to 99:1 by weight with polymers made by ATRP or FRP.
